(19) United States
(12) Patent Application Publication
(10) Pub. No.: US 2012/0308441 A1
(43) Pub. Date: Dec. 6, 2012

(54) Method and Apparatus for Production of Electrical Energy and Liquid Hydrocarbons from Oil Sands/Bitumen, Biomass and Waste Products by Means of Thermal Anaerobic Gasification Gas Up-Grading

(76) Inventor: Andrew Hansen, Bullhead City, AZ (US)

(21) Appl. No.: 13/486,966

(22) Filed: Jun. 1, 2012

Related U.S. Application Data
(63) Continuation-in-part of application No. 12/590,550, filed on Nov. 10, 2009.
(60) Provisional application No. 61/201,837, filed on Dec. 15, 2008.

(51) Int. Cl. B01J 12/00

(52) U.S. Cl. 422/187

(57) ABSTRACT

A method and apparatus for producing clean electrical energy, and liquid hydrocarbons, as well as various types of useable by-products from biomass, waste products and oil sand. Uniquely, the apparatus includes a plurality of inclined pyrolysis units arranged in tandem that are heated by the combination of an infra-red system and by heat produced by the pyrolysis units.

### CROSS-REFERENCE TO RELATED APPLICATIONS

This is a Continuation-In-Part Application of co-pending U.S. Non-Provisional application Ser. No. 12/590,550 filed Nov. 10, 2009 claiming the benefit of co-pending Provisional Application No. 61/201/837 filed on Dec. 15, 2008.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention relates generally to a method and apparatus for the production of electrical energy and liquid hydrocarbons. More particularly, the invention concerns a method and apparatus for producing electrical energy and liquid hydrocarbons from oil sands, biomass and waste products by means of a pyrolysis process.

2. Description of Related Art Including Information Disclosed Under 37 CFR 1.97 and 1.98

The development of new sources for energy has become a priority for most countries around the world and declining oil reserves, growing environmental awareness and political issues surrounding fossil fuels have renewed the interest in alternate sources of energy. Promising energy sources have been recognized to include oil sands, biomass and waste products.

Pyrolytic decomposition is a known method of disposing of solid waste and it has long been recognized that valuable products may be obtained from the pyrolysis process. The early U.S. Pat. No. 4,759,300 issued to the present inventor describes a method and apparatus for use in processing waste materials of various kinds and for reclaiming useable by-product materials from the pyrolized waste materials. The waste materials to be pyrolized are efficiently dehydrated prior to their introduction into the pyrolysis retort using microwaves generated by a large microwave generator. After the waste material is dried, initial ignition is accomplished using a very high intensity laser beam. Laser ignition is continued until sufficient methane and other volatile gases are produced for burning in a burner unit to sustain the pyrolysis reaction.

U.S. Pat. No. 3,702,039 issued to Stookey et al. is exemplary of another prior art method and apparatus for treating waste materials for recovering valuable materials including a fuel gas and liquid hydrocarbons. In accordance with the Stookey et al. method, the waste materials are charged to the upper end of a vertical gasification chamber and preheated air blast is introduced into the hearth thereof. A producer gas is generated within the gasifier at such a temperature that metal, glass and other noncombustibles are reduced to a molten condition. As waste materials move downwardly under gravity, the hot producer gas moves upwardly, pyrolyzing an organic portion of the waste materials. The gases evolved in the gasifier are passed from the upper end thereof and contacted with a cooling liquor comprising water. Thus, entrained particulate and a condensable portion including liquid hydrocarbons are separated from the evolved gases into a liquid phase whereby a fuel gas is produced.

With regard to biomass, U.S. Pat. No. 7,834,226 issued to Miller concerns a method and system for producing biofuels via a combination of biomass, waste plastic, and/or Fischer-Tropsch product feeds. In one embodiment, the Millar invention is directed to a method comprising the steps of: pyrolyzing biomass concurrently with a second material such as waste plastic and/or Fischer-Tropsch wax, so as to yield pyrolysis oil; separating rating the pyrolysis oil into at least two component fractions according to boiling range; hydrotreating at least one of the at least two component fractions so as to yield at least one hydrotreated intermediate; and catalytically-isomerizing the at least one hydrotreated intermediate so as to yield at least one isomerized product.

### BRIEF SUMMARY OF THE INVENTION

It is an object of the present invention to provide a novel method and apparatus for producing clean electrical energy, and liquid hydrocarbons, as well as various types of useable by-products from biomass, waste products and oil sand.

More particularly, it is an object of the invention and novel design to provide a method for producing energy and liquid hydrocarbons and useable by-products from biomass, waste products and oil sands that involves subjecting the materials to a pyrolysis reaction within a novel pyrolysis sub-system that includes plurality of pyrolysis units

Another object of the present invention is to provide a novel method of gas collection, movement, sampling, reintroduction, mixture, blending and up-grading of gases and synthetic gases within the pyrolysis units and system to form higher energy and liquid hydrocarbon production.

Uniquely, the plurality of pyrolysis units arranged in series/tandem are heated by a combination of infra-red system and redirected heat or waste heat produced monitored and controlled by the system that produces the required heat range of 800° to 1,600° F. and concentrates the heat on the bottom one-third of each retort without impinging on the retort itself.

Another object of the present invention is to provide a novel method of heat and flue gas diversion by means and use of heat/gas diversion manifolds that is operably associated with the pyrolysis subsystem and functions to permit the metering and redirection of portions of the heat/flue-gas streams from either the thermal oxidizer and/or from the gas turbines to be directed via various routes, to various pieces of equipment.

Another object of the present invention is to provide an apparatus of the character described that includes a thermal oxidizer that is operably associated with the pyrolysis subsystem and functions to take in the mixture, blended and up-graded gases and synthetic gases and fire them, producing heat that will be directed to a boiler for the production of steam, and the creation of redirected heat or waste heat to be used as system heat rate within pyrolysis subsystem.

Another object of the present invention is to provide an apparatus of the character described in the preceding paragraphs that further includes waste heat boiler equipment that is operably associated with the pyrolysis subsystem and functions to produce steam for production of electrical energy and for further use within a high temperature electrolysis subsystem for production of hydrogen.

Another object of the present invention is to provide an apparatus of the character described that includes steam super heater equipment that is operably associated with the pyrolysis subsystem and high temperature electrolysis subsystem and functions to increase steam temperature and pressure.

Another object of the present invention is to provide an apparatus of the character described that includes a high temperature electrolysis unit subsystem that is operably associated with the pyrolysis subsystem and functions to take in heat steam and electrical energy and produces hydrogen for use in gas up-grading of gases produced within the pyrolysis subsystem and or catalytic conversion and/or closed fractioning tower.

Another object of the present invention is to provide an apparatus of the character described in the preceding paragraphs that further includes a catalytic converter and/or closed fractionizing tower of novel design that further includes internal catalytic components that is operably associated with the pyrolysis subsystem and into which the pyrolysis products from the pyrolysis subsystem pass. Within the catalytic converter and/or novel design closed fractionizing tower, the stream of pyrolysis gas flowing from the pyrolysis subsystem is further hydrogenated, then gas/condensate separated into various products that become the subject of further treating and/or hydrogenation, or gas collection.

Another object of the present invention is to provide an apparatus of the character described in the preceding paragraphs that that is operably associated with the pyrolysis subsystem that further includes a high temperature ceramic filter that is installed intermediate the membrane oxygen extraction subsystem and the end of the last converter/retort of the pyrolysis subsystem, the high temperature ceramic filter functioning to clean the gases received by the pyrolysis subsystem without lowering the temperature to a level that would initiate condensation.

Another object of the present invention is to provide an apparatus of the character described in the preceding paragraphs that that is operably associated with the pyrolysis subsystem, further includes a membrane oxygen extraction subsystem that is installed intermediate to gas stream gas clean-up equipment for removal of chlorine and other compounds and/or contaminates and after the high temperature, ceramic filter functioning to extract oxygen from the gas stream.

Another object of the present invention is to provide an apparatus of the character described in the preceding paragraphs that is operably associated with the pyrolysis subsystem that further includes gas clean-up equipment for removal of chlorine and other compounds and/or contaminates that is installed intermediate the catalytic converter and/or novel design closed fractionizing tower and gas turbine generator and the membrane oxygen extraction subsystem functioning to clean the gases received by the pyrolysis subsystem without lowering the temperature to a level that would initiate condensation.

Another object of the present invention is to provide an apparatus of the class described in the preceding paragraphs that is operably associated with the pyrolysis subsystem that further includes a gas fired turbine generator that receives gases post gas filtering and cleanup activities and functions to generate electricity that can be made available to the grid system and/or apparatus, while generating heat rate to be used by the pyrolysis subsystem.

Another object of the present invention is to provide an apparatus of the class described in the preceding paragraphs that is operably associated with the pyrolysis subsystem that further includes a steam turbine generator and co-generation steam turbine equipment that receives steam from the boiler and functions to generate electricity that can be made available to the grid system and/or apparatus, while generating heat rate to be used by the pyrolysis subsystem.

Another object of the present invention is to provide an apparatus of the character described in the preceding paragraphs that is operably associated with the pyrolysis subsystem in which the last pyrolysis unit of the pyrolysis subsystem is designed to drop the final residual material, or carbon char, from the pyrolysis subsystem through an air-lock into a quench and dry subsystem water circulated bath in a manner to maintain the oxygen-free environment. The collected char is then dried, bagged and forwarded to fixed carbon markets, and/or processed into other value added products such as activated carbon.

Another object of the present invention is to provide an apparatus of the character described in the preceding paragraphs that is operably associated with the pyrolysis subsystem that further includes a closed wet scrubbing subsystem for flue gases that take in all flue gases and residual heat rate and naturalizes acids and cools gases and heat rate.

### BRIEF DESCRIPTION OF SEVERAL VIEWS OF THE DRAWINGS

FIGS. 1A and 1B when considered together comprise a generally diagrammatic view illustrating one form of the method and apparatus of the invention for producing liquid hydrocarbons from coal.

FIG. 2 is an enlarged side elevational view of the pyrolysis, or retort portion, of the apparatus of the invention shown in FIG. 1B.

FIG. 3 is an enlarged side elevational, diagrammatic view, partly broken away to show internal construction, of the feed module subassembly of the retort portion of the apparatus of the invention shown in FIG. 2.

FIG. 4 is an enlarged side elevational, diagrammatic view of one of the transition module subassemblies of the retort portion of the apparatus of the invention shown in FIG. 2.

FIG. 5 is an enlarged side elevational, diagrammatic view of the last, or gas take off module subassembly of the retort portion of the apparatus of the invention shown in FIG. 2.

FIG. 6 is a greatly enlarged cross-sectional, diagrammatic view taken along lines 6-6 of FIG. 3.

FIG. 7 is a greatly enlarged cross-sectional, diagrammatic view taken along lines 7-7 of FIG. 4.

FIGS. 8A and 8B when considered together comprise a generally diagrammatic view illustrating an alternate form of the method and apparatus of the invention.

FIG. 9 is a greatly enlarged cross-sectional view of one of the plurality of inclined pyrolysis unit housings of the invention showing the appearance of the two side-by-side retorts that are housed within each of the pyrolysis unit housings.

FIG. 10 is an enlarged side elevational view of the pyrolysis, or retort portion, of the apparatus of the invention shown in FIG. 8A.

### DETAILED DESCRIPTION OF THE INVENTION

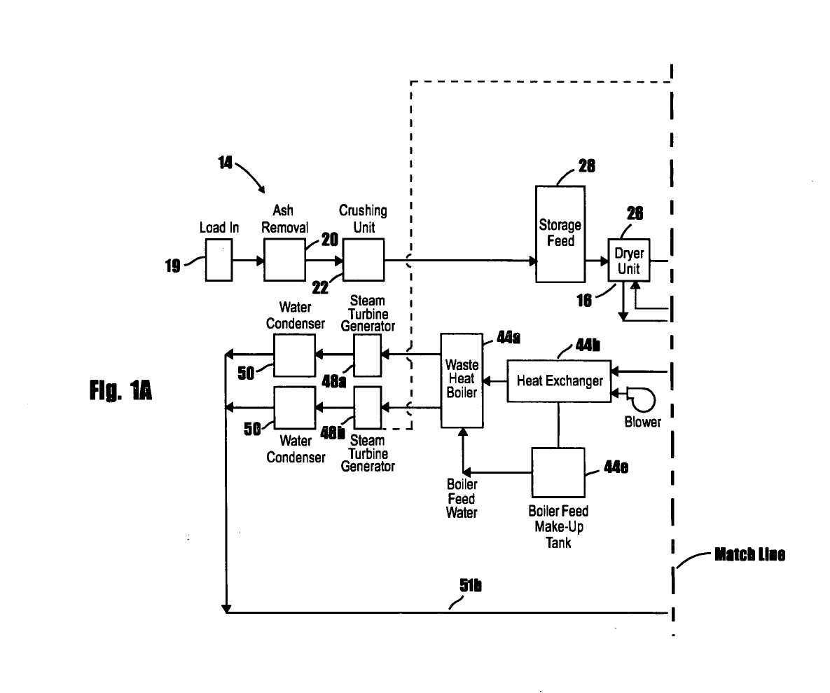

Referring to the drawings and particularly to FIGS. 1A and 1B, one form of the method and apparatus of the invention for producing liquid hydrocarbons from coal and like hydrocarbon materials is there shown in a generally diagrammatic form. The apparatus here comprises a material input section generally designated as 14, a pyrolysis, or retort section generally designated as 16 (FIG. 1B) and a fractionating section generally designated as 18.

The material input section 14 here includes a feed, or load-in station and an ash removal station 20 wherein the ash is removed from the coal in a conventional manner to produce a substantially ash free coal. Section 14 also includes a crushing station 22 wherein the ash free coal is crushed to produce a crushed coal.

The pyrolysis, or retort section 16 here includes a conventional dryer unit 26 which receives the desulfurized crushed coal from a storage unit 28 and functions to dry the desulfurized crushed coal. Section 16 also includes a plurality of pyrolysis units, or retorts 30, the details of construction of which will presently be described. The pyrolysis, or retort section 16 further includes a fuel cell system generally designated by the numeral 32 that is operably associated with the retorts 30 and functions to produce electrical energy in a conventional manner.

With regard to the pyrolysis section, pyrolysis may be defined as the chemical decomposition of organic materials by heating in the absence of oxygen or any other reagents. Pyrolysis has long been known to those skilled in the art of waste treatment as an effective process for reducing the organic components of a variety of compositions of waste material, such as conventional industrial and municipal waste, to products which present no harm to the atmosphere and which can be used in whole or in part to provide a useful source of energy or a material that can be recycled into a product having commercial value. One very successful pyrolytic waste treatment system is described in U.S. Pat. No. 5,868,085 in which the present inventor is named as a co-inventor.

The pyrolytic process employs high temperature in, most desirably, an atmosphere substantially free of oxygen (for example, in a practical vacuum) to convert the solid organic components of waste to other states of matter; such pyrosylates in a liquid or vapor phase.

A typical waste treatment system utilizing pyrolysis has an input structure for introducing the waste; a chamber or retort from which air can be purged and in which pyrolysis processing occurs; a feature for raising the temperature inside the chamber; an element that allows the vaporized waste material or “off-gases” to be vented to the environment, which element may or may not include some feature for cleaning or scrubbing the gases; and an assembly through which is discharged the solid or molten residue of the pyrolytic conversion process.

Other features often are provided to continuously move waste through the treatment unit while the system is being operated, such as a form of conveyance arrangement. Screw conveyors or conveyor belts oriented at an incline have been used to ramp waste material, in units of a defined volume and at a defined rate of flow, up from a storage bin or pre-treatment assembly at the ground level to a charging hopper at the top of the treatment unit through which waste is metered into the pyrolytic chamber. Screw conveyors, auger screws and worm conveyors all have been used to impel waste through the retort while pyrolysis takes place, again, to encourage predictable results from the process.

It is well known that the efficiency of pyrolysis is negatively affected by the presence of oxygen. One of the adverse effects oxygen has is to increase the degree to which the chemical reactions taking place during conversion are explosive, which explosiveness, in turn, increases the turbulence in the chamber and tends to result in the recombination of the released gases with the solid material being processed, making the conversion less complete and thus inefficient.

The manner in which the retort chamber is supplied with heat energy to sustain pyrolysis also can affect the efficiency with which the process can be carried out. For example, it has been found that uniform application of heat to the outer wall of the retort, through which it is conducted into the interior of the chamber, reduces the risk that the retort will buckle from uneven distribution of high temperatures and tends to encourage a more even distribution of heat and consistency of temperature throughout the chamber, which leads to consistent processing results. System features provided to address even heating have included those directed to the manner in which the primary source of heat energy, commonly fuel gases being combusted in a heating chamber, is arranged with relation to the retort, and the number and placement of fuel gas injection ports, etc.

Referring once again to FIG. 1B of the drawings, the fractionating section 18 of the invention here includes a conventional closed fractionating tower 34 and an operably associated hydrogen production system 36. Interconnected with the closed fractionating tower 34 is a conventional gas turbine generator 38. The turbine generator 38 and the fuel cells 32a, 32b, 32c and 32d of the fuel cell system 32 are operably interconnected with an electrical sub-station 42.

The process of one form of the invention involves the step of using the ash removal station 20 to first wash the coal that is delivered to the site as “mine run”, to remove ash, dirt, stones and like foreign matter. Next, using conventional hammer mills, jaw crushers, or like material reduction equipment, the washed product is crushed in the crushing unit 22 to produce a washed, crushed product having a size of about one half inch, or smaller. As illustrated in FIG. 1B, the apparatus of the invention also includes a generating system that includes a waste heat boiler 44a, a series of heat exchangers 44b, 44c and 44d and a boiler feed make-up tank 44e (FIGS. 1A and 1B).

As illustrated in FIG. 1A of the drawings, the waste heat boiler 44a is interconnected with a pair of conventional steam turbine generators 48a and 48b, each of which is, in turn, connected to a second water condenser 50. Water condensers 46 and 50 are interconnected by conduits 51a and 51b with the water system 52 (FIG. 1B), the details of construction of which will presently be described.

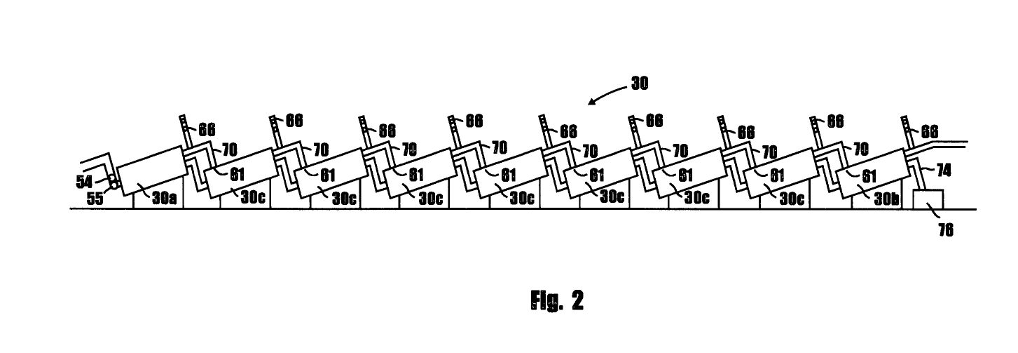

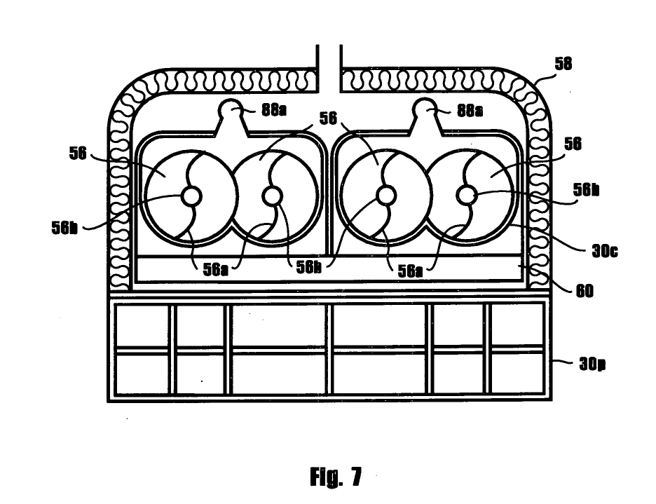

Following the crushing step, the material is transferred to the storage feed tank 28. From the storage feed tank the material is transferred to the previously identified dryer unit 26 and is stored in vibratory cone bottom tanks, each one of which will service one line of nine pyrolysis unit housings 30. Uniquely, the drying unit 26 is designed to receive waste heat from heat exchangers 44c and 44d. From the drying unit 26 weight feeders will then deposit precise quantities of the dried material onto a conveyer belt (not shown) that feeds the material into 2′×2′ openings in each air lock 54 of the first pyrolysis unit housing 30a (FIGS. 3 and 6) at a rate of about 0.4 cubic feet per second.

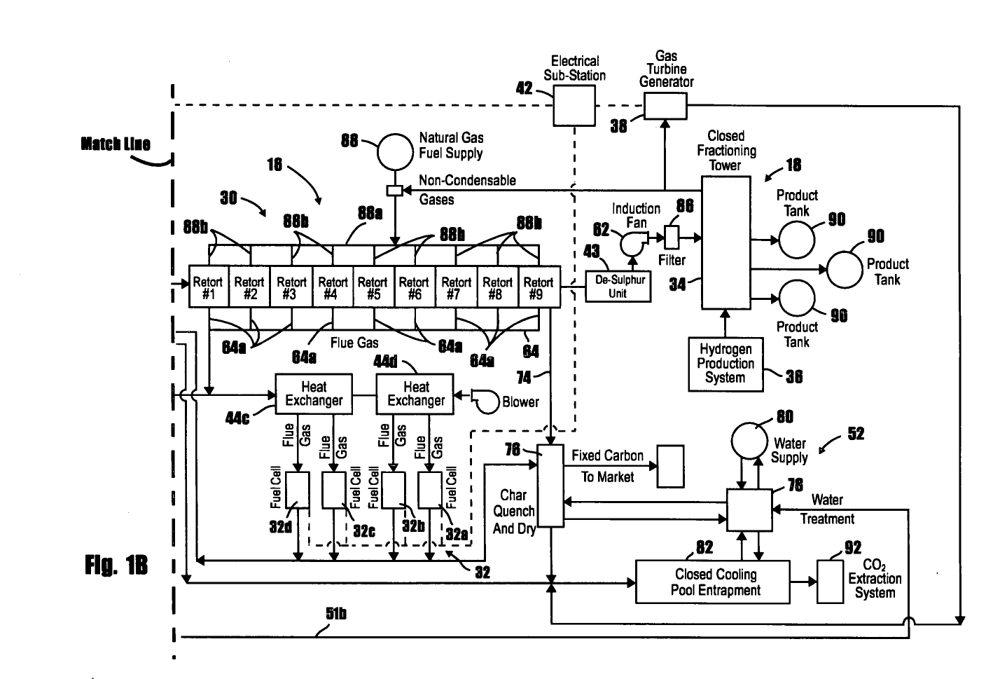

As illustrated in FIGS. 2, 6 and 7, the apparatus of the present form of the invention comprises a plurality of pyrolysis unit housings 30 arranged in tandem. In the present embodiment of the invention each pyrolysis unit housing 30 houses two side-by-side retorts 31a and 31b (FIG. 6) for a total of 18 retorts. However, depending on nature of the organics and the total cubic feet per day of material being processed, more or less retorts may be provided. In this regard, it should be noted that the initial prior art pyrolytic waste treatment systems were stationary “batch” reaction vessels. This approach was partially successful, but prone to explosive situations where off gases were not exhausted fast enough to maintain a negative pressure in the furnace.

The first “continuous flow” pyrolytic waste treatment systems made use of double chamber rotary valves at the entry and exit points of a centrally-located reaction vessel, termed a “retort.” To ensure completion of the pyrolytic reactions, the waste material was required to remain within the retort for a minimum specified time, termed the “required resident time.”

To increase the amount of feedstock that can be handled within the required resident time, designers tried increasing the length of the retort chamber which, when combined with an increase in the speed of the material through the chamber, would have permitted a greater amount of feedstock per unit of time. Unfortunately, experience revealed that if the chamber extends longer than about thirty feet, the material conveying screw sags, making contact with the walls of the retort chamber and causing the screw motor to fail.

For this reason, consideration was given towards expanding the diameter of the retort, again with the goal of increasing the amount of feedstock that could be pyrolyzed in a given amount of time. This design stratagem also proved a failure. Retort vessels of increasing diameter experienced a failure in the required particle movement resulting in the incomplete combustion of the organic particles.

This problem that plagued prior art pyrolytic waste treatment systems was uniquely solved by the present inventor by providing the novel tandem reactor design illustrated in FIG. 2 of the drawings.

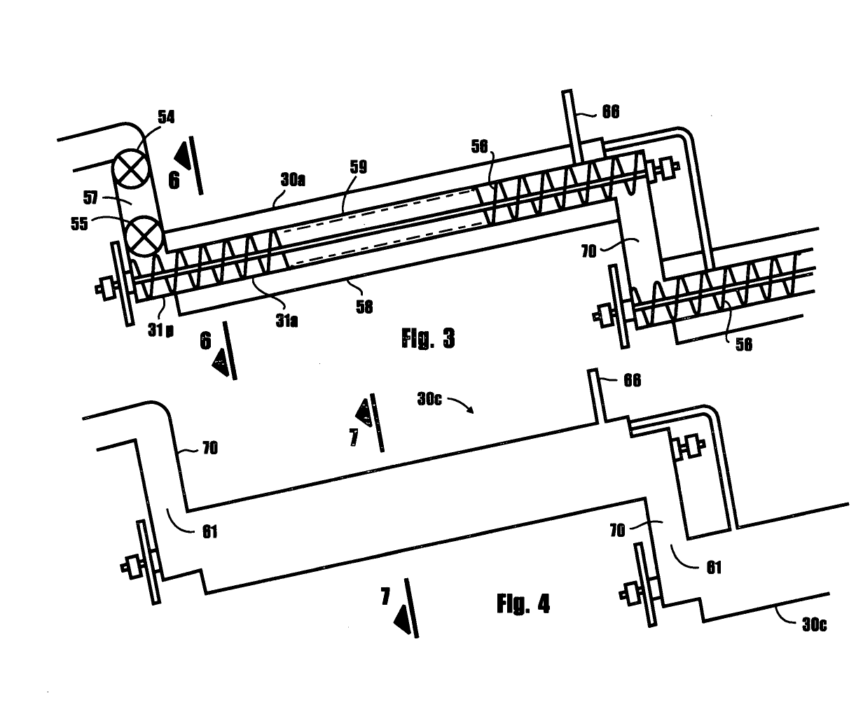

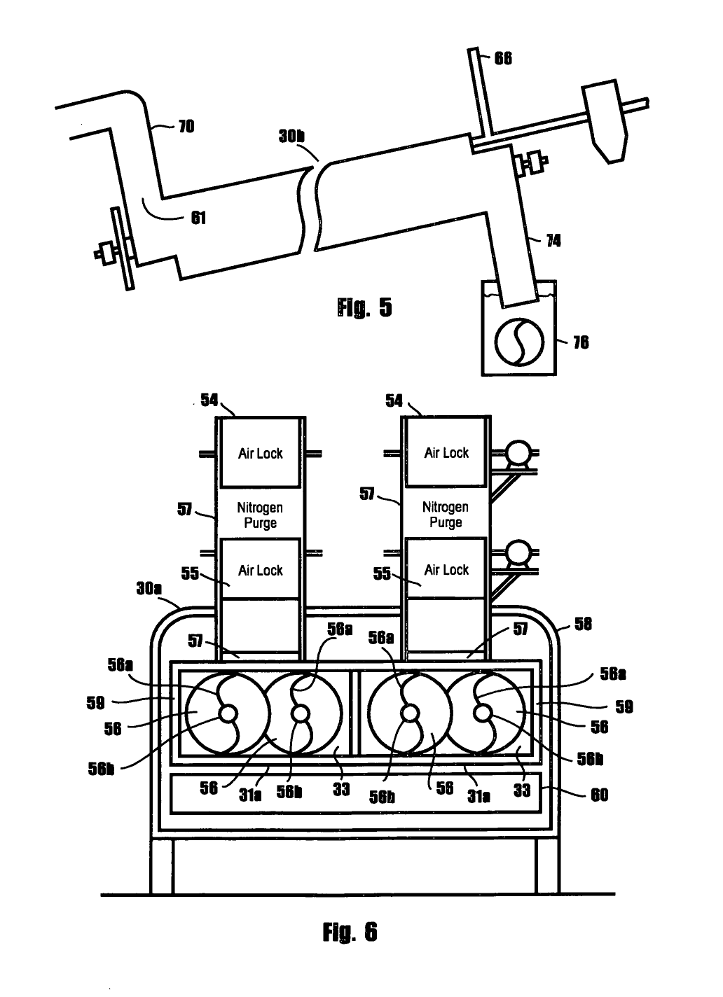

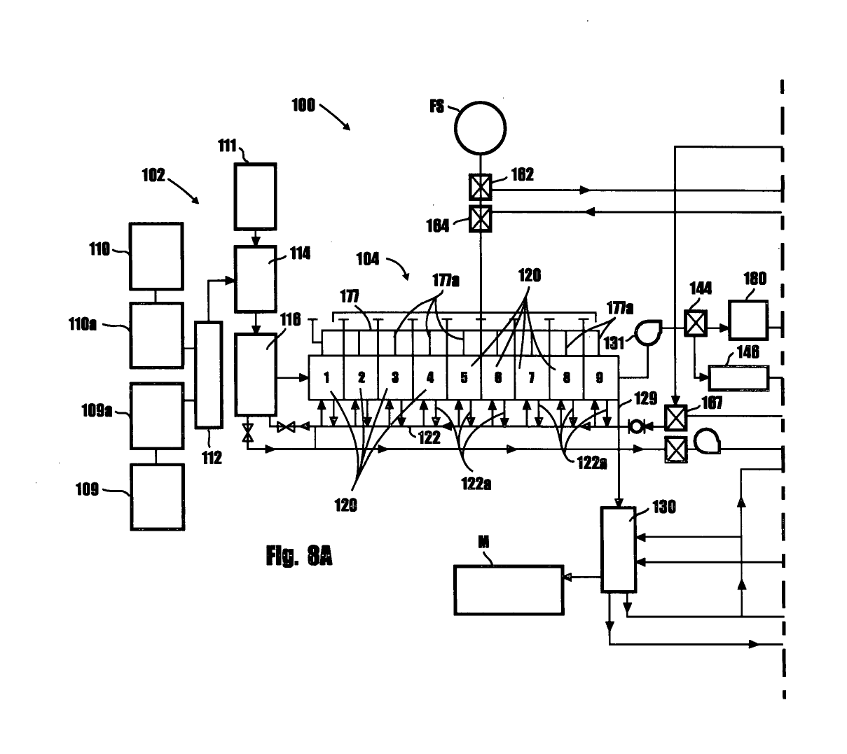

In the present form of the invention, each retort 31 of the plurality of tandem retorts (shown in the drawings as retorts 1-9) is about five feet wide and about 30 feet long and each retort includes two thirty-inch diameter helical screws 56 (FIGS. 6 and 7), with one feed entry 57 to each retort (FIG. 6). The helical screws 56 are driven at a controlled rate of rotation by conventional motors (not shown) that are housed within each retort housing. All of the pyrolysis unit housings 30, which are supported by eight-inch I beam platforms 30p (FIG. 7), are of substantially the same configuration. However, pyrolysis unit housing 30a (FIGS. 3 and 6), and the last pyrolysis unit housing 30b, or retort #19 (FIGS. 1B and 5), are of the somewhat different construction shown in FIGS. 3 and 5, while intermediate pyrolysis unit housings 30c are of the general construction illustrated in FIGS. 4 and 7.

As best seen in FIGS. 3 and 6, a nitrogen infusion chute 57 having a length of approximately thirty-six inches is provided between the first and second rotary air locks 54 and 55. Rotary air locks 54 and 55 are of conventional construction, serve their normal function, and are readily commercially available from various sources, including Sunco Power Systems Inc. of Charlotte, N.C.

With the construction described in the preceding paragraphs, nitrogen is infused into the chute 57 via a perforated pipe located immediately below the bottom of the first air lock 54 (not shown). Material introduced into the first rotary air lock 54 proceeds through the second rotary air lock 55 and drops by force of gravity into that portion 31p of the retorts 31a that extend past the insulated outer shell 58 (see, for example, FIG. 3).

Each retort 31 is housed within a stainless steel screw housing 59 (FIG. 6) and is heated by a conventional infra-red system 60 (FIGS. 6 and 7) that produces the required heat range of 950° to 1200° F. and concentrates the heat on the bottom one-third of the retort without impinging on the retort itself. Heat energy is provided/generated within the outer insulating housing 58, typically through the combustion of a petroleum product such as natural gas.

The various components that make up the conventional infra-red system 60 are readily commercially available from various sources, including Eclipse Power Equipment Co. of Richmond, Va. As previously mentioned, the operating temperature of each individual retort 31 can be raised or lowered as desired. An induction fan 62 located proximate the end of the last housing 30b ensures the maintenance of a negative pressure in the line of retorts and the evacuation of a minimum amount of particulate matter (FIG. 1B).

The material introduced into the air locks proceeds through the sequential pyrolytic converter and is decomposed by heat in an oxygen-free environment into various gas and solid components. The rotary air locks function to prevent the entry of oxygenated air into the pyrolytic chambers 33 of the first retorts 31a. Once introduced into the pyrolytic chambers of the retorts 31a via the rotary air locks, the helical conveyors 56 sequentially force the desulfurized material through the pyrolytic chambers 33 at a measured pace that is calculated to provide the appropriate resident time within the retort. As indicated in FIGS. 6 and 7, the helical conveyor 56 here comprises a blade 56a wrapped about a central shaft 56b.

In operation of the apparatus, the material passes via the transitional units which are of the construction illustrated in FIG. 4 from the first retort 31a to the second retort in line, and then sequentially to each of the retorts that make up the pyrolysis portion 16 via the inlets 61 provided on each retort (see FIG. 2).

Gases are carried continuously from each retort through a gas plenum 64 that is attached to the screw housing 59 by a series of transfer pipes 64a (FIG. 18). In this regard, it is to be noted that all metals used in the retort, gas plenum, retort shell and screws are of the same A.S.T.M. number to maintain the same co-efficient of expansion throughout the system.

Ports 66 are installed proximate the ends of the pyrolysis unit housings, both to sample the gas make-up or to remove the gas at that point if desired. For example, if mercury is discovered as a contaminant it can be removed and condensed as a solid/liquid by distillation-condensation at a certain point as it moves through the multiple retorts.

In the preferred form of the invention, the total retention time of the material within the retorts is approximately 27 minutes. This means that the material will only remain in each retort for approximately 3 minutes after which it then drops through the drop-out chute 70 that extends past the insulated outer shell on the end of the retort and into the receiving end or input 61 of the following retort.

The last pyrolysis unit housing 30b is designed to drop the final residual material which comprises a carbon char, through a drop-out chute 74 into a quench and dry system 76 (FIG. 5). From the quench and dry system 76 the char is transferred to a water bath 78 in a manner to maintain the oxygen-free environment. As seen in FIG. 1B, water bath 78 forms a part of the water system 52 which also includes a water supply 80 and a closed cooling pool entrapment 82. After drying, the char is dried and bagged and forwarded to the fixed carbon market. Quench and dry system 70 is of conventional construction and is readily commercially available from various sources, including the Lundell Manufacturing Company of Cherokee, Iowa.

From retort 31b, or retort #9, the material is treated to remove harmful sulfur. In this regard, over the years it has been recognized that sulfur, which is a particularly troublesome impurity in coal, can be from trace amounts up to about 7 percent by weight. Sulfur may be found in coal in various forms, e.g., organic sulfur, pyritic sulfur, or sulfate sulfur. In accordance with one form of the method of the present invention, sulfur is removed from the pyrolyzed product in the filter type desulfurizing station 43 (FIG. 1B). Desulfurizing station 43 is readily commercially available from the Pall Shumacher Company of Crailshaim, Germany. This company should be consulted for the details of construction and operation of the filter-type desulfurizing station 34.

A high temperature ceramic filter 86 is installed proximate the end of the last retort to clean the gases and to remove fine carbon from the gas stream and to remove any residual sulfur therefrom without lowering the temperature to a level that would initiate condensation. Ceramic filter 86 is of conventional construction and is readily commercially available from various sources, including Caldo Engineering of Bromsgrove, England.

Gases flow from the ceramic filter 86, to the closed fractionating tower 34, and to the previously mentioned gas fired turbine generator 38, to generate electricity that can be made available to the grid system.

After filtration, the desulfurized pyrolysis products pass to the closed fractionizing tower 34 wherein the stream of pyrolysis condensate is separated into various products that become the subject of further hydrogenation and treating. Fractioning tower 34 is of conventional construction and operation and is readily commercially available from various sources, including the Service and Technology Corp. of Bartlesville, Okla. In processing the pyrolysis products, the overhead distillate from the tower 34 is cooled and the distillate is typically separated into pyrolysis gas, tar water and light hydrocarbon condensate. Normally, part of the condensate is returned as reflux to the top of the tower and the excess is taken off as product.

In processing the pyrolysis gas, the composition and quality of the paralysis gas changes quite sharply. The long-term action of high temperatures on the absorption oil and the continuous increase in content of heavy hydrocarbons extracted from the paralysis products into the oil will bring about partial polymerization of the material and hence an increase an increase in viscosity.

As depicted in FIG. 1B, the non-condensable gases such as hydrogen and carbon monoxide are removed at the top of the fractioning tower 34 for use in ethanol production. A portion of the hydrogen can also be used to upgrade yield of liquid petroleum products in the fractioning tower and to blend with natural gas from the natural gas supply 88 for use in heating the retorts 31 via a gas plenum 88a that includes connector pipes 88b (FIG. 1B). The liquid petroleum products in the fractioning tower that are derived from the pyrolysis products are transferred to a series of product tanks 90 for periodic removal and appropriate disposition.

During operation, the apparatus of the invention, the previously mentioned electrical sub-station 42, will acquire all the electrical energy derived from the fuel cells, the gas turbine generator and the steam generator, and make any surplus available to the grid system.

As illustrated in FIGS. 1A and 1B, a portion of the flue gases will be fed to the dryer unit 26 to dry the feed material. The balance will be used to supply heat energy to the series of fuel cells 32a, 32b, 32c and 32d via heat exchangers 44c and 44d. Any residual heat will be used to heat the waste heat boiler 44a that will supply steam to power the steam turbine generator 48a. The fuel cells 30 are of conventional construction and are readily commercially available from various sources, including United Technologies Corporation of Hartford, Conn. Similarly, heat exchangers 44c and 44d are of conventional construction and are readily commercially available from various sources, including Hayden Industrial Products of Corona, Calif.

Any waste residual gases will be diverted to a covered pool entrapment 82 and a carbon dioxide extraction system 92 will be appropriately associated with the covered pool entrapment 82, to remove the carbon dioxide gas and containerize it for shipment.

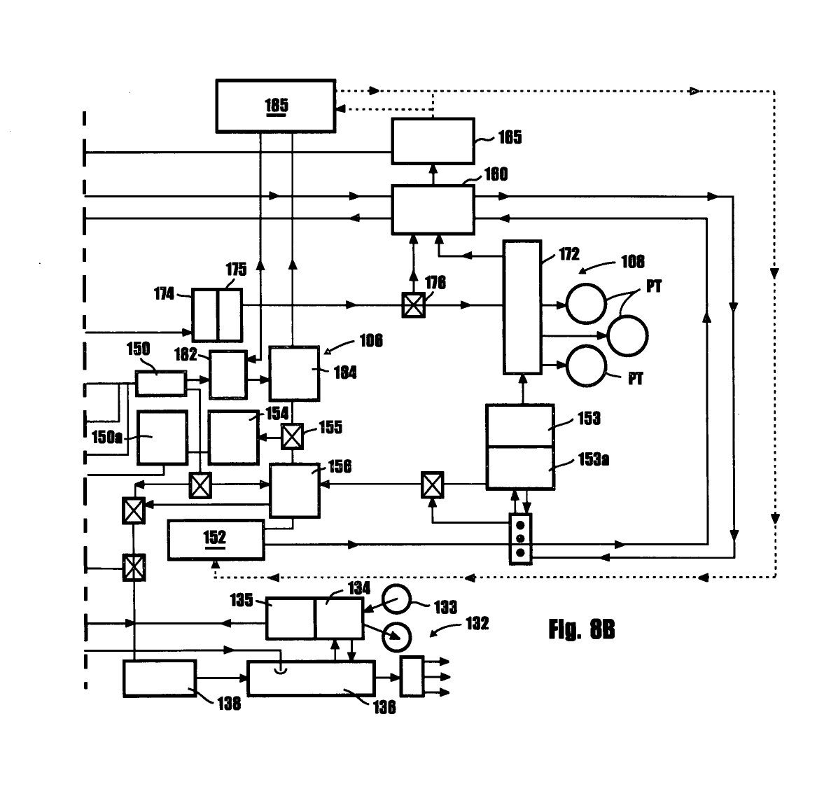

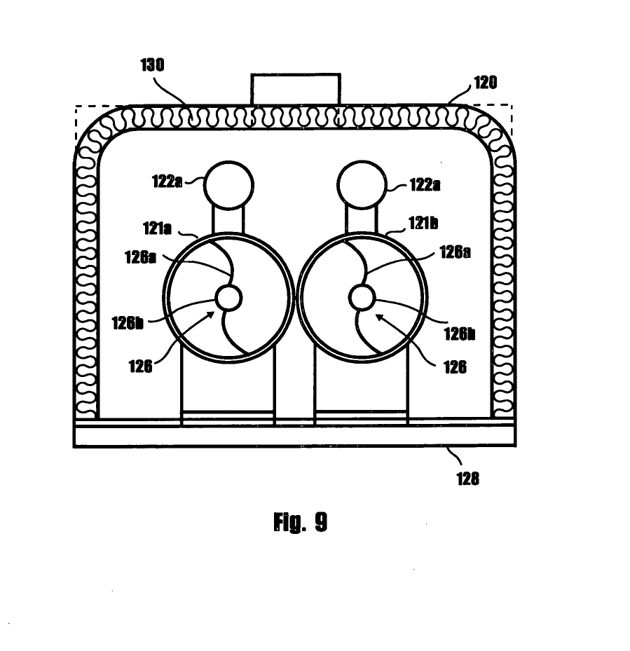

Turning now to FIGS. 8A, 8B and 9, an alternate form of the method and apparatus of the invention is there shown and generally designated by the numeral 100. This alternate form of the apparatus is similar in some respects to that shown in FIGS. 1 through 7 and like numerals are used in FIGS. 8 and 9 to identify like components. As previously mentioned, the method and apparatus of this latest form of the invention concerns the production of electrical energy and liquid hydrocarbons from oil sands, biomass and waste products by means of a pyrolysis process.

As the term is used herein, biomass means living, or recently living organisms. Industrial biomass can be grown from numerous types of plants, including a variety of tree species. The term oil sands as used herein refers to loose sand or partially consolidated sandstone containing naturally occurring mixtures of sand, clay and water, saturated with a dense, viscous form of petroleum.

As best seen in FIGS. 8A and 8B, the apparatus of this latest form of the invention comprises a material input section generally designated as 102, a pyrolysis, or retort section generally designated as 104 (FIG. 8A), a generating section 106 and a fractionating section generally designated as 108:

The material input section 102 here includes a waste load-in station 109, a waste feed station 109a, a biomass load-in section 110, a biomass feed section 110a and an oil sands feed station 111. The pyrolysis, or retort section 104 includes a shredder 112 that is in communication with waste feed station 109a and biomass feed station 110a. Shredder 112 is of conventional construction and functions to appropriately shred the waste and biomass materials received from load in sections 109a and 110a. Shredder 112 is in communication with a conventional feed pump 114 that receives the shredded waste and shredded biomass materials from the shredder 112 and transfers it a conventional dryer unit 116. Feed pump 114 also receives the oil sand from the feed station 111 and transfers it to the dryer unit. Dryer unit 116 functions to effectively dry the shredded waste and shredded biomass material as well as the oil sand received from the feed station 111.

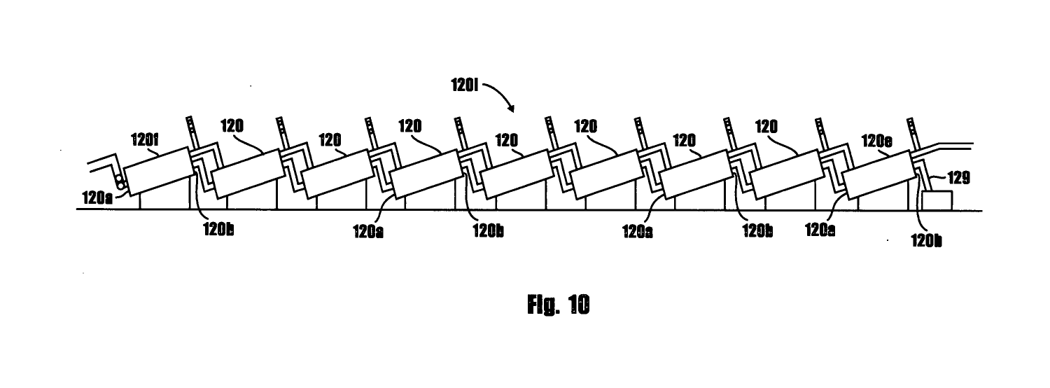

The pyrolysis section 104 includes a plurality of a plurality of pyrolysis unit housings 120, the construction and operation of which is similar to that previously described in connection with the embodiment of FIGS. 1 through 7. As before, the plurality of inclined pyrolysis unit housings 120, each of which has first and second ends 120a and 120b, are arranged in tandem with the second end elevated above the first end of the adjacent housing (FIG. 10). Each housing 120 includes two side-by-side retorts 121a and 121b (FIG. 9) for a total of 18 retorts. However, depending on nature of the organics and the total cubic feet per day of material being processed, more or less retorts may be provided. Each of the retorts is heated by a combination of infra-red and redirected heat or waste heat produced, monitored and controlled by the retort system that produces the required heat range of 800° to 1,600° F.

As indicated in the drawings, the apparatus includes various heat/gas diversion manifolds, including manifold 122, that are operably associated with the pyrolysis subsystem and which function to permit the metering and redirection of portions of the heat/flue-gas streams to various pieces of equipment.

In this latest form of the invention, each retort of the plurality of tandem retorts is about five feet wide and about 30 feet long and each retort includes two thirty inch diameter helical screws 126 with one feed entry to each retort. The helical screws 126 are driven at a controlled rate of rotation by conventional motors (not shown) that are housed within each retort housing. All of the pyrolysis unit housings 120, which are supported by eight-inch I beam platforms 128 (FIG. 9), are of substantially the same configuration. However, as before, the first and last pyrolysis unit housings 120f and 1201 are of the somewhat different construction shown in FIGS. 3 and 5, while intermediate pyrolysis unit housings 120i are of the same general construction.

As in the earlier described embodiment, the first pyrolysis unit housing 120f is provided with a nitrogen infusion chute, similar to chute 57, which chute is located between the first and second rotary air locks that are of conventional construction similar to air locks 54 and 55 (see FIG. 3). With this construction, nitrogen is infused into the nitrogen infusion chute via a perforated pipe located immediately below the bottom of the first air lock. Material introduced into the first rotary air lock proceeds through the second rotary air lock and drops by force of gravity into the first retorts.

Each retort is heated by a conventional infra-red system of the character previously described that produces the required heat range of 950° to 1450° F. and concentrates the heat on the bottom one-third of the retort without impinging on the retort itself. Heat energy is provided/generated within the outer insulating housing 130 (FIG. 9), typically through the combustion of a petroleum product such as natural gas provided from a natural gas fuel supply “FS”.

An induction fan 131 located proximate the end of the last pyrolysis unit housing 1201 ensures the maintenance of a negative pressure in the line of retorts and the evacuation of a minimum amount of particulate matter (FIG. 8A).

The material introduced into the air locks proceeds through the sequential pyrolytic converters and is decomposed by heat in an oxygen-free environment into various gas and solid components. The air locks function to prevent the entry of oxygenated air into the pyrolytic chambers of the first retorts. Once introduced into the pyrolytic chambers of the retorts via the air locks, the helical screws 126 sequentially force the material through the pyrolytic chambers at a measured pace that is calculated to provide the appropriate resident time within the retort. As indicated in FIG. 9, the helical screws 126 here comprises a blade 126a wrapped about a central shaft 126b.

In operation of the apparatus, the material passes via the transitional units from the first retort to the second retort in line, and then sequentially to each of the inclined retorts that make up the pyrolysis portion via the inlets 127 provided on each retort (see FIG. 10).

Gases are carried continuously from each retort through a gas outlet 122a (FIG. 9) and a manifold 122 that is attached to the screw housing by a series of transfer pipes 122a (FIG. 8A). As before, ports are installed proximate the ends of the pyrolysis unit housings, both to sample the gas make-up and to remove the gas at that point, if desired. For example, if mercury is discovered as a contaminant it can be removed and condensed as a solid/liquid by distillation-condensation at a certain point as it moves through the multiple retorts.

In the preferred form of the invention, the total retention time of the waste material and the biomass material within the retorts is approximately 27 minutes. This means that the material will only remain in each retort for approximately 3 minutes after which it then drops through the drop-out chute that extends past the insulated outer shell on the end of the retort and into the receiving end or input of the following retort.

The last pyrolysis unit housing 1201 is designed to drop the final residual waste and biomass material which comprises a carbon char, through a drop-out chute 129 into a quench and dry system 130 (FIG. 8A). From the quench and dry system the char is transferred to a water system 132 in a manner shown in the drawings so as to maintain the oxygen-free environment. As seen in FIG. 8B, water system 132 includes a water supply 133, a water treatment plant 134, a water pumping plant 135, and a closed cooling pool entrapment 136. Interconnected with the closed cooling pool entrapment 136 is a closed wet scrubbing subsystem 138 that functions to effectively scrub the flue gases.

After drying, the char is dried and bagged and forwarded to the fixed carbon markets “M”, or is processed into other value added products such as activated carbon. Quench and dry system 130 is of conventional construction and is readily commercially available from various sources, including the Lundell Manufacturing Company of Cherokee, Iowa.

Operably associated with the last pyrolysis unit housing 1201 via induction fan 131 and a diversion valve 144 is a thermal oxidizer 146. Induction fan 131 functions to ensure the maintenance of a negative pressure in the line of retorts and the evacuation of a minimum amount of particulate matter. Thermal oxidizer 146 functions to take in the mixture of blended and up-graded gases and synthetic gases and fire them, producing heat that will be directed to a waste heat boiler 150 (FIG. 8B). Waste boiler 150, which is fed by a boiler feed 150a, functions to produce steam for the production of electrical energy and for further use within a high temperature electrolysis subsystem 152. High temperature electrolysis unit subsystem 158 functions to produce hydrogen for use in the up-grading of gases produced within the pyrolysis subsystem. The hydrogen produced is transferred to a hydrogen product system 153 via a manifold 153a. As depicted in FIG. 8B, boiler feed 150a is operably associated with a conventional steam condenser 154. Waste heat boiler 150 is also operably associated via a valve 155 with a super heater 156 that functions to increase the steam temperature and pressure. As shown in FIG. 8, the produced hydrogen flows from the high temperature electrolysis unit subsystem 152 to the pyrolysis subsystem via gas manifolds 160, 162 and 164. Gas manifold 160 also communicates with a gas turn line 165 which, in turn, communicates with manifold 122 via a diverter valve 167.

Referring once again to FIG. 8B of the drawings, the fractionating section 18 of the invention here includes a conventional closed fractionating tower 172. Closed fractionating tower 172, which includes internal catalytic components, is operably associated with a membrane oxygen extraction subsystem 174 and gas clean-up subsystem or extraction system 175 via a valve 176. As indicated in FIG. 8B, within the catalytic converter and closed fractionizing tower the stream of pyrolysis gas flowing from the pyrolysis subsystem is further hydrogenated, then the gas/condensate is separated into various products that become the subject of further treating, hydrogenation, and gas collection. As before, the non-condensable gases such as hydrogen and carbon monoxide can be removed at the top of the fractioning tower for use in ethanol production. A portion of the hydrogen can also be used to upgrade yield of liquid petroleum products in the fractioning tower and to blend with natural gas from the natural gas fuel supply “FS” for use in heating the retorts via a gas plenum 177 that includes connector pipes 177a (FIG. 8A). The liquid petroleum products in the fractioning tower that are derived from the pyrolysis products are transferred to a series of product tanks “PT” for periodic removal and appropriate disposition.

The apparatus of the invention further includes a high temperature ceramic filter 180 that is installed intermediate the membrane oxygen extraction subsystem 174 and the last pyrolysis unit housings 1201. High temperature ceramic filter 180 functions to clean the gases received by the pyrolysis subsystem without lowering the temperature to a level that would initiate condensation. During system operation, the membrane oxygen extraction subsystem 174 effectively removes oxygen, while extraction system 175 removes chlorine and other contaminates after the high temperature ceramic filter has extracted oxygen from the gas stream.

An important feature of the apparatus of this latest form of the invention is the provision of a conventional steam turbine generator 182 and a conventional co-generation steam turbine 184. As indicated in FIG. 8B, these generators receive steam from the waste heat boiler 150 and function to generate electricity that can be made available to the grid system via electrical sub-station 42.

Having now described the invention in detail in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention, as set forth in the following claims.

1. An apparatus for producing electrical energy and liquid hydrocarbons from oil sands/bitumen, biomass and waste products by means of a pyrolysis process, said apparatus comprising:
(a) a material input section including a shredder for shredding the biomass and waste products to produce a shredded material;
(b) a pyrolysis section including:
(i) a dryer unit for drying said shredded material and said oil sands to produce a substantially dry material;
(ii) a plurality of inclined pyrolysis unit housings arranged in tandem for pyrolizing said substantially dry material to produce a pyrolyzed product; and
(iii) a generating section operably associated with said plurality of pyrolysis unit housings for producing electrical energy; and
(c) a fractionating section comprising a closed fractioning tower and a hydrogen production system operably associated with said closed fractionating tower for producing hydrogen.

2. The apparatus as defined in claim 1 further including a membrane oxygen extraction subsystem that is operably associated with said plurality of inclined pyrolysis unit housings for cleaning gases generated within said plurality of inclined pyrolysis unit housings.

3. The apparatus as defined in claim 1 in which each of said plurality of inclined pyrolysis unit housings of said pyrolysis section includes two side-by-side retorts, each retort including a helical screw.

4. The apparatus as defined in claim 1 in which said generating section includes a steam generating system operably associated with said inclined pyrolysis unit housings, said steam generating system including a waste heat boiler and a steam turbine generator interconnected with said waste heat boiler.

5. The apparatus as defined in claim 4 further including a thermal oxidizer operably associated with said inclined pyrolysis unit housings and with said waste heat boiler for producing heat to heat said waste heat boiler.

6. The apparatus as defined in claim 4 further including a super heater that is operably associated with said waste heat boiler for increasing the temperature and pressure of the steam produced by said waste heat boiler.

7. The apparatus as defined in claim 4 further including a water system operably associated with said waste heat boiler for providing water to said waste heat boiler, said water system comprising a water supply, a water treatment plant, a water pumping plant and a closed cooling pool entrapment.

8. An apparatus for producing electrical energy and liquid hydrocarbons from oil sands/bitumen, biomass and waste products by means of a pyrolysis process, said apparatus comprising:
(a) a material input section including a shredder for shredding the biomass and waste products to produce a shredded material;
(b) a pyrolysis section including:
(i) a dryer unit for drying said shredded material and said oil sands to produce a substantially dry material;
(ii) a plurality of inclined pyrolysis unit housings arranged in tandem for pyrolizing said substantially dry material to produce a pyrolyzed product, each said pyrolysis unit housing including two side-by-side retorts, each retort having a helical screw; and
(iii) a membrane oxygen extraction subsystem operably associated with said plurality of inclined pyrolysis unit housings for cleaning gases generated within said plurality of inclined pyrolysis unit housings; and
(c) a generating section operably associated with said plurality of pyrolysis unit housings for producing electrical energy, said generating section comprising a steam generating system operably associated with said inclined pyrolysis unit housings, said steam generating system including a waste heat boiler and a steam turbine generator interconnected with said waste heat boiler; and
(d) a fractionating section comprising a closed fractioning tower and a hydrogen production system operably associated with said closed fractionating tower for producing hydrogen.

9. The apparatus as defined in claim 8 in which said pyrolysis section further includes a gas fired infra-red system operably associated with said side-by-side retorts for controllably heating said side-by-side retorts.

10. The apparatus as defined in claim 8 further including a thermal oxidizer operably associated with said inclined pyrolysis unit housings and with said waste heat boiler of said generating section for producing heat to heat said waste heat boiler.

11. The apparatus as defined in claim 8 further including a super heater that is operably associated with said waste heat boiler for increasing the temperature and pressure of the steam produced by said waste heat boiler.

12. The apparatus as defined in claim 8 further including a water system operably associated with said waste heat boiler for providing water to said waste heat boiler, said water system comprising a water supply, a water treatment plant, a water pumping plant and a closed cooling pool entrapment.

13. The apparatus as defined in claim 8 further including a high temperature ceramic filter, said high temperature ceramic filter being installed intermediate said membrane oxygen extraction subsystem and said plurality of inclined pyrolysis unit housings.

14. An apparatus for producing electrical energy and liquid hydrocarbons from oil sands, biomass and waste products by means of a pyrolysis process, said apparatus comprising:
(a) a material input section including a shredder for shredding the biomass and waste products to produce a shredded material;
(b) a pyrolysis section including:
(i) a dryer unit for drying said shredded material and said oil sands to produce a substantially dry material;
(ii) a plurality of inclined pyrolysis unit housings arranged in tandem for pyrolizing said substantially dry material to produce a pyrolyzed product and for generating gases, each said pyrolysis unit housing including two side-by-side retorts, each retort having a helical screw;
(iii) a gas fired infra-red system operably associated with said side-by-side retorts for controllably heating said side-by-side retorts; and
(iv) a membrane oxygen extraction subsystem operably associated with said plurality of inclined pyrolysis unit housings for cleaning gases generated within said plurality of inclined pyrolysis unit housings; and
(c) a generating section operably associated with said plurality of pyrolysis unit housings for producing electrical energy, said generating section comprising a steam generating system operably associated with said inclined pyrolysis unit housings, said steam generating system including a waste heat boiler and a steam turbine generator interconnected with said waste heat boiler; and
(d) a fractionating section comprising a closed fractioning tower and a hydrogen production system operably associated with said closed fractionating tower for producing hydrogen.

15. The apparatus as defined in claim 14 further including a thermal oxidizer operably associated with said inclined pyrolysis unit housings and with said waste heat boiler of said generating section for producing heat to heat said waste heat boiler.

16. The apparatus as defined in claim 14 further including a super heater that is operably associated with said waste heat boiler for increasing the temperature and pressure of the steam produced by said waste heat boiler.

17. The apparatus as defined in claim 14 further including a water system operably associated with said waste heat boiler for providing water to said waste heat boiler, said water system comprising a water supply, a water treatment plant, a water pumping plant and a closed cooling pool entrapment.

18. The apparatus as defined in claim 14 further including a series of transfer pipes disposed within said pyrolysis unit housings for withdrawing generated gases therefrom.
